(19) United States
(12) Patent Application Publication
(10) Pub. No.: US 2018/0246586 A1
(43) Pub. Date: Aug. 30, 2018

(54) Electronic Input Device

(71) Applicant: Robert A. Hillman, Poway, CA (US)

(72) Inventor: Robert A. Hillman, Poway, CA (US)

(21) Appl. No.: 15/443,809

(22) Filed: Feb. 27, 2017

(51) Int. Cl. G06F 3/0354; G06F 3/01; G06F 3/03

(52) U.S. Cl. CPC G06F 3/0354; G06F 3/0304; G06F 3/016

(57) ABSTRACT

An electronic input device is disclosed having an orientation monitor, and a support in contact with a user, wherein the orientation monitor monitors a movement of the support, wherein the movement of the support is determined by the user, and wherein the movement of the support is communicated to an electronic device to provide user input of the electronic device. A method of providing input to an electronic device is also disclosed, having the steps of a user sitting on a support, a user moving on the support, an optical sensor receiving an image reflected from the surface of the support, the optical sensor continually monitoring the surface of the support, a processor determining the trends of the optical signals, and the processor sending a signal determination to the electronic device.

### BACKGROUND OF THE INVENTION

### 1. Field of Invention

The present invention relates to the field of computer cursor control and more specifically to object movement detection utilized to provide input to an electronic device, wherein the object is movable by movement of the human body.

### 2. Description of Related Art

Currently, computer mice, trackpads and rollerballs are used in conjunction with a computer allowing the individual to manipulate a cursor on the computers screen by movement of the device or movement of the fingers along a surface. These devices detect two-dimensional motion relative to a surface and relay the analysis to a cursor on a computers display. This allows the user to navigate a graphical user interface of the computer. A plurality of buttons may be positioned on the mouse or trackpad allowing the user to select files, programs, or actions.

A few variants of mice currently exist. Mechanical mice comprise a ball disposed within a body, wherein the movements of the ball are recorded according to how the ball moves rollers. Rollers positioned on an x- and y-axis grip the ball and transfer movement that is detected mechanical components or infrared LED's. Sensors gather light pulses and convert the data into x and y vectors on the display. This style of mouse was popular into the early 2000's when newer technology was developed.

One inherent problem with mechanical mice was their propensity to become jammed. It was common for the rubber track ball to pick up debris that would then be deposited into the body of the mouse. Optical mice were created as a remedy to these problems. The new design used LED's and an image sensor (such as CMOS or CCD) to detect movement of the mouse relative to the underlying surface.

A trackpad is a pointing device featuring a tactile sensor, a specialized surface that can translate movement by the motion and position of a user's fingers to a relative position on the operating system that is outputted to the screen. Trackpads are a common feature of laptop computers, and are also used as a substitute for a mouse where desk space is scarce. Because they vary in size, they can also be found on personal digital assistants (PDAs' and some portable media players. Wireless touchpads are also available as detached accessories.

Trackpads operate in one of several ways, including capacitive sensing and resistive touchscreen. The most common technology uses entails sensing the capacitive virtual ground effect of a finger, or the capacitance between sensors. Capacitance-based trackpads will not sense the tip of a pencil or other similar implement. Gloved fingers may also be problematic.

For common use as a pointer device, the dragging motion of a finger is translated into a finer, relative motion of the cursor on the output to the display on the operating system, analogous to the handling of a mouse that is lifted and put back on a surface. Hardware buttons equivalent to a standard mouse's left and right buttons are positioned below, above, or beside the trackpads.

Some trackpads may interpret tapping the pad as a click, and a tap followed by a continuous pointing motion (a “click-and-a-half”) can indicate dragging. Tactile trackpads allow for clicking and dragging by incorporating button functionality into the surface of the touchpad itself. To select, one presses down on the trackpad instead of a physical button. To drag, instead performing the “click-and-a-half” technique, one presses down while on the object, drags without releasing pressure and lets go when done. Trackpad drivers can also allow the use of multiple fingers to facilitate the other mouse buttons (commonly two-finger tapping for the center button).

Some trackpads have “hotspots”, locations on the touchpad used for functionality beyond a mouse. For example, on certain trackpads, moving the finger along an edge of the touch pad will act as a scroll wheel, controlling the scrollbar and scrolling the window that has the focus vertically or horizontally. Many trackpads use two-finger dragging for scrolling. Also, some trackpad drivers support tap zones, regions where a tap will execute a function, for example, pausing a media player or launching an application. All of these functions are implemented in the trackpad device driver software, and can be disabled.

While current technology allows the user to exhibit precise screen dexterity, standard mice, trackpads and trackballs contribute to a sedentary lifestyle that is plaguing society with numerous long-term health problems. Being overweight with a lack of exercise leads to chronic pain and shortened lives. Further, the fine motor movements required to provide input to the computer create chronic conditions such as carpal tunnel syndrome.

Video games are controlled by customized controllers having numerous buttons, control joysticks and motion sensors. The motions that the players' hands must go through may produce overuse injuries such as tennis elbow or carpal tunnel syndrome. Video games also encourage a sedentary lifestyle due to the manner in which users interact with the consoles, which contributes to overweight children. Some video games are controlled by movement of the user's body, such as Microsoft™ Kinect, which helps with user fitness, but is limited in interaction, and does not lend itself to sophisticated input such as a controller might provide.

Based on the foregoing, there is a need in the art for a computer integrated cursor manipulation system that analyzes users body movement by movement of a support and transmits the movement to an electronic device, to provide pointing information to a computer or video game input, without motor movement that is hazardous to a user's health.

### SUMMARY OF THE INVENTION

An electronic input device is disclosed having an orientation monitor, and a support in contact with a user, wherein the orientation monitor monitors a movement of the support, wherein the movement of the support is determined by the user, and wherein the movement of the support is communicated to an electronic device to provide user input of the electronic device.

The orientation monitor may be in communication with a biasing mechanism that biases the orientation monitor towards the support. The optical transmitter may be configured to transmit a signal to the support, and the optical receiver is configured to receive a reflection of the signal from the support, and wherein a movement of the support is determined by comparing the signals received by the optical receiver.

The optical transmitter or orientation monitor may be part of a gaming system. The orientation monitor may have one or more accelerometers to provide movement information over one or more axes.

In another embodiment, the electronic input device has an orientation monitor comprising a camera having a lens, wherein the lens is configured to focus on the support, and a support in contact with a user having a pattern thereon, wherein the orientation monitor monitors a movement of the support by observation of the pattern, wherein the movement of the support is determined by the user, and wherein the movement of the support manipulates a graphical user interface.

The pattern may involve a pattern image positioned on the support. There may also be a light source, wherein the light source emits light onto the support and optionally onto the user. The device may also have a plurality of rollers supporting the support, wherein the orientation monitor is positioned below the support and monitors a position of the support, and the support rotates in a fixed position on the rollers.

The orientation monitor may be defined by a plurality of rollers, and the support may be in contact with the plurality of rollers. The device may have a pressure sensor, wherein the pressure sensor manipulates the graphical user interface.

A method of providing input to an electronic device is disclosed, having the steps of a user sitting on a support, a user moving the support, an optical sensor receiving an image from the surface of the support, the optical sensor monitoring the surface of the support, a processor determining the trends of the optical signals, and the processor sending a signal determination to the electronic device.

The additional step of the optical sensor transmitting a signal against the surface of the support may also be present, and an additional step may be the user tapping the support to produce a mouse click.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an isometric view of the input device, according to an embodiment of the present invention;

FIG. 2 is an isometric view of the input device, according to a further embodiment of the present invention;

FIG. 3 is an isometric view of the input device, according to a further embodiment of the present invention; and

FIG. 4 is an isometric view of the input device, according to a further embodiment of the present invention; and

FIG. 5 is a flowchart view of method of using the input device, according to a further embodiment of the present invention.

FIG. 6 is an elevation detail view of the input device, according to a further embodiment of the present invention.

FIG. 7 is a elevation detail view of a further embodiment of the present invention.

FIG. 8 is a detail view of a mouse biased against the support, according to a further embodiment of the present invention.

FIG. 9 is a detail view of features within the support, according to a further embodiment of the present invention.

### DETAILED DESCRIPTION OF PREFERRED EMBODIMENTS

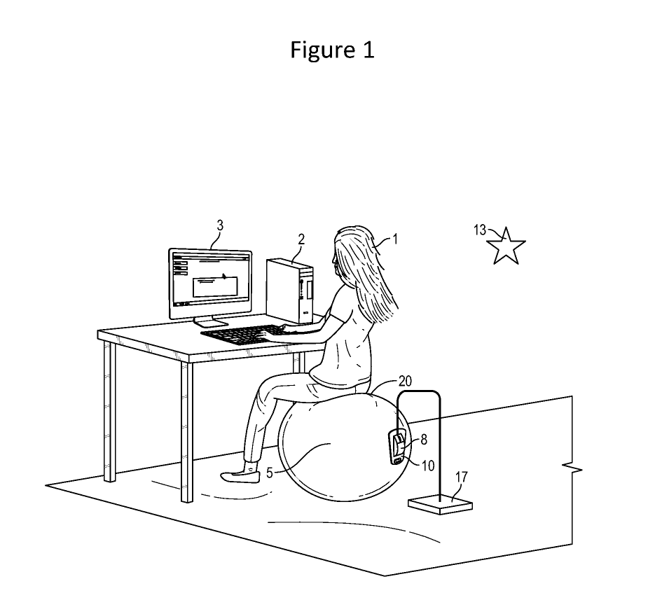

Preferred embodiments of the present invention and their advantages may be understood by referring to FIGS. 1-9, wherein like reference numerals refer to like elements.

In general, the following invention related to an input device for computer systems, wherein the user engages with a support and moves the support to provide input to the computer system, wherein the system interprets the movements and wherein the input may be used by the computer to operate a cursor or to provide gaming controls, for example.

In reference to FIG. 1, a user 1 is positioned in front of a computer screen 3, with a CPU connected thereto, and sitting atop a support 5. In an embodiment the cursor manipulation support 5 comprises a large medicine ball or inflatable exercise ball, however, a multitude of shapes and devices may be used, so long as the user can sit on or in it. Examples of a support 5 are an exercise ball (sometimes called a stability ball or balance ball), foam ball or a portion of a curved ball or curved shape, foam block, or a chair that lets the user lean. Some office chairs have legs on the bottom but on the top have a curved section like a ball to sit on, rather than a seat, in effect a hybrid between an exercise ball and an office chair, so long as they are conducive to being sat on by a user and moved by the user's muscle movements. The system further comprises an orientation monitor 8, for monitoring orientation and movement of the support 5. In one embodiment, shown in FIG. 1, an optical transmitter and receiver 10 (in one embodiment, within a single unit) form the orientation monitor 8 and are positioned such that the support is within a measurable operation range, wherein the optical transmitter 10 transmits a signal and the integrated receiver receives the signal, and a processor 14 (not shown) analyzes the received data and determines a movement of the support 5.

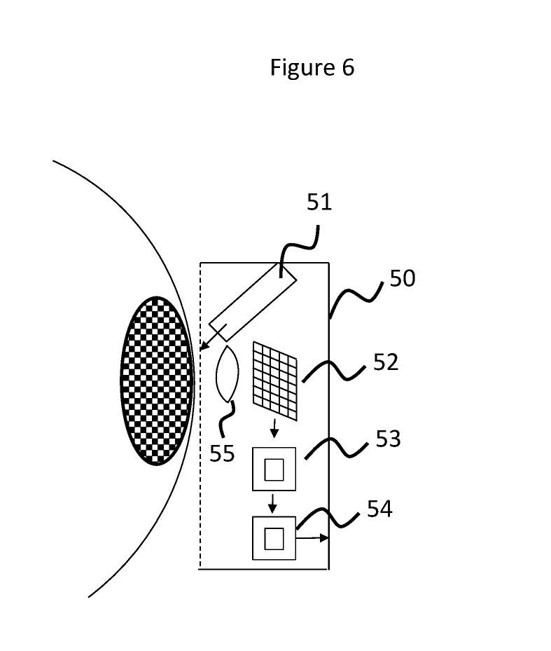

See an example detail view of FIG. 6 which shows the light source, lens, sensor and processor and interface that communicates to the electronic device for input. For example, orientation monitor 50 detects support movement. A light source 51 provides light to reflect off the support, and the image sensor 52 senses the image of the support, and provides the image to the processor 53. The processor 53 analyzes a series of images of the support and determines a position and/or movement of the support, wherein the processor may be implemented in software, FPGA or ASIC to analyze the image sensor data. The monitor 50 comprises an I/O interface 54 operating on Bluetooth, Wi-Fi, USB or other protocols known in the art. A lens 55 may be present between the image sensor and the support to focus the image, as well as an optional optical filter (not shown).

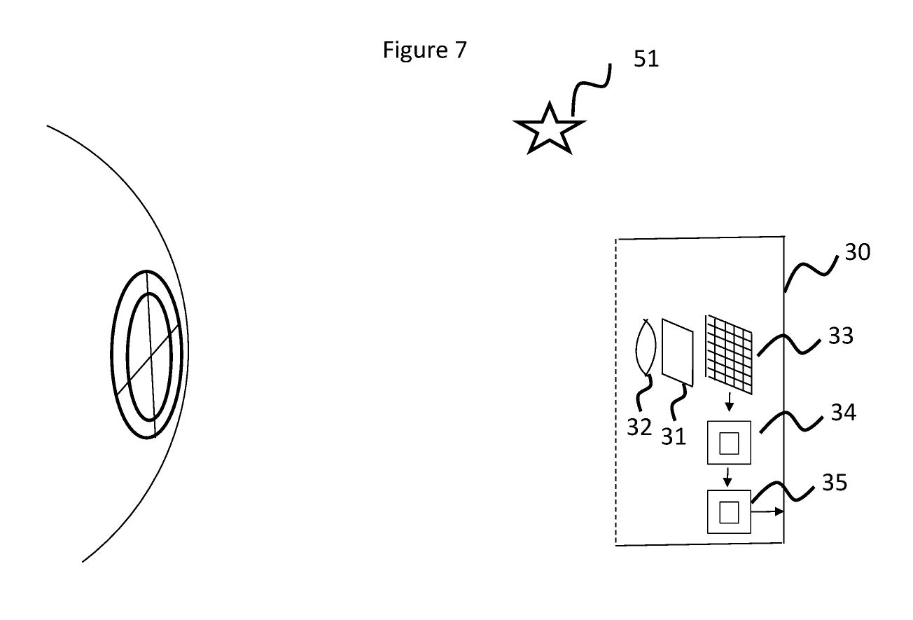

As another embodiment, FIG. 7 shows a detail view of the orientation monitor 30 that detects support movement, comprising an optional optical filter 31, a lens 32 focused on support pattern 21, an image sensor 33, processor/logic 34 (potentially as an ASIC or FPGA) to analyze image sensor data, and an I/O interface 35 such as Bluetooth, Wi-Fi, USB etc. A light source 51 may also be present to illuminate the area.

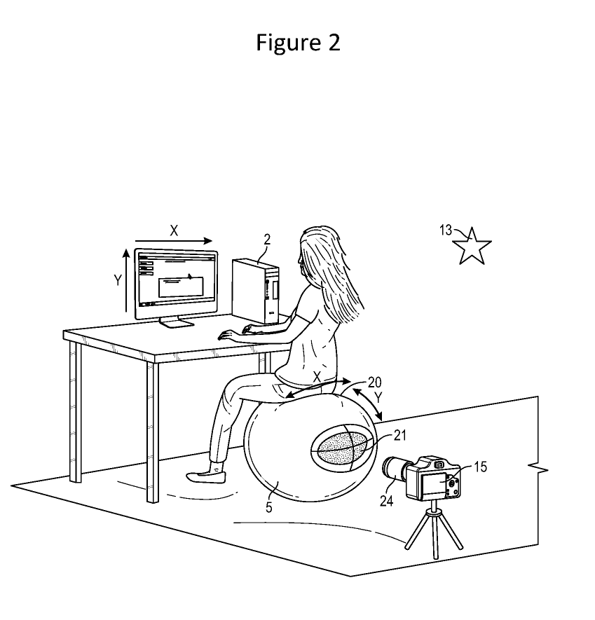

Although the system may include a light source transmitter or RF signal transmitter in order to determine the movement of the support, alternatively it may be able to use simply ambient room light, such as a camera 15 containing a receiver for the optical signal therein, such that the system would not need to transmit any signal to the support. This is most feasible in the embodiment of FIG. 2.

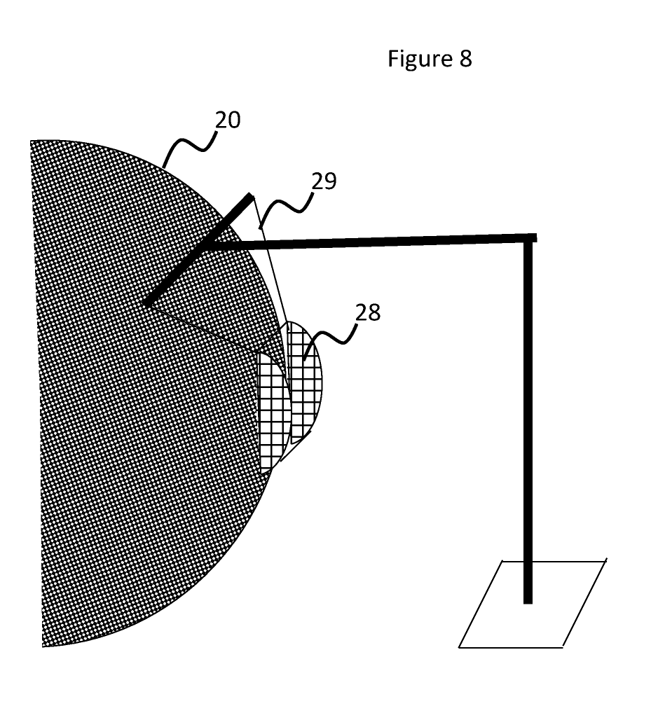

In an embodiment shown in FIG. 8, the orientation monitor comprises generally a computer mouse 28 in contact with the surface 20 of the support. The mouse 28 may determine movement by monitoring the movement of the support beneath the mouse base, either by optical means or mechanical means such as perpendicular rollers to determine movement in 2 dimensions. The mouse 28 may be held against the surface 20 by biasing means or by weight of the mouse 28 itself, suspended by one or more flexible supports 29 such as strings or cables. There could be a pattern or a mouse pad-like texture on the surface 20 of the support. Alternate methods to keep the orientation monitor in close proximity to the support include having the user hold the mouse with their hand and be able to move the cursor either through movement of the support or movement with their hand moving the orientation monitor on the support. This may be on the side of the support as their hand would naturally rest on the side of the support, and coordinates could be converted to appropriate x, y coordinates based on the location of the orientation monitor. Coordinate translation would change based on location(s) of the orientation monitor(s) so for example the orientation monitor on the side of the support would have different translation than if it were on the back of the support.

In an embodiment, with reference to FIG. 1, a small light source 13 is used to control illumination on the ball to maintain lighting consistency. As the user 1 moves their body, and thus rolls, compresses, or bounces the support 5, the monitor detects such movement and transmits data to the computer 2 which the computer 2 interprets as it does mouse input, and moves a cursor on a computer screen 3 in accordance with the movement of the support 5, or moves a gaming character on the screen 5, allowing the user to engage with the graphical user interface. The embodiment shown in FIG. 1 optionally includes a biasing mechanism extending from a base 17 that applies force to the orientation monitor 8 to keep the orientation monitor 8 close to the support 5, such that the orientation monitor 8 and base 17 are connected or in close proximity even when the support 5 moves left/right or forward/backwards. The monitor base 17 may be a rigid frame that extends above the orientation monitor 8 to both sides and extends slightly above the support 5 so that if the support 5 moves forward and away from the base 17, the monitor 8 would still be close enough to the support. In one embodiment string 12 could be attached at both ends of the support 17 to hold monitor 8 in position so that the user movement would not move the monitor 8 and could be used to detect the support 5 movement while keeping the monitor 8 in contact with the support 5 or surface 20. Prior art optical mice usually required the surface (stationary mousepad or desk) they are measuring to be very close or in contact with the bottom of the mouse due to the focal length of the optics and the light source and to avoid ambient light interference.

In an embodiment, as the user rolls the support 5, the optical monitor 8 or 15 receives optical data through an active-pixel sensor (APS) (not shown) within the receiver, such as a complementary metal-oxide-semiconductor (CMOS). With reference to FIG. 6, the APS is able to analyze movement corresponding to an x-axis, and y-axis, each of which accounts for a specific manipulation of the cursor in the graphical user interface. In an embodiment, x- and y-axis, and optionally a z-axis movement is generated by an accelerometer attached or embedded within the support.

In an embodiment, the monitor 15 is in communication with a material or a surface 20 on the support 5. The material or surface 20 may contain a pattern 21 such as reference lines, texture, or other reference materials to aid in motion detection by the monitor 15, such that light (either ambient room light or supplemental light source 13 illuminates the surface 20 and the sensor receives an image that can be used to determine the surface movement and thus the support 5 movement. In an embodiment, a pattern 21 of light is projected onto the support surface 20 and the camera 15 measures distortion of the pattern; in another embodiment there is texture 21 on the support 5 and the receiver 10 monitors the movement of the pattern/texture to determine bounce, or user movement. Patterns may use different colors for easier detection of relevant pattern movement, and optical sensors may use optical filters to filter out light other than the relevant pattern to make image processing easier.

In reference to FIG. 2, a position-monitoring device is used to analyze graphical data that relates to the support movement, and transmit the data to the computer 2 wherein the graphical user interface is manipulated. In an embodiment, the position-monitoring device is a CMOS image sensor (See FIG. 7) and lens, within the monitor 15, where the lens is designed to focus on the support 5 and transfer a plurality of pattern 21 images on the support to the image sensor to detect the movement of the support 5 (in an embodiment, with an optional light source, or using room light). The position-monitoring device 15 is positioned in a way such that the support 5, and optionally the user 1 are positioned within the device's 15 field-of-view after taking into account possible valid movement. More than one position monitoring device can be used, and the location of the position-monitoring device could be behind the support 5, in front, or side, above or below.

In another embodiment, the position-monitoring device 15 may comprise a plurality of sensors within the support 5, such as accelerometers arranged with perpendicular sensing axes, to determine when the support 5 is rolled forward or backward, as opposed to side to side. A movement sensor may also be present to determine a click, created by a tap or bounce by the user on the support 5. In order to maintain calibration and a sense of which way is down, a gravitation sensor (similar to an accelerometer) may be present to determine when the support 5 is centered.

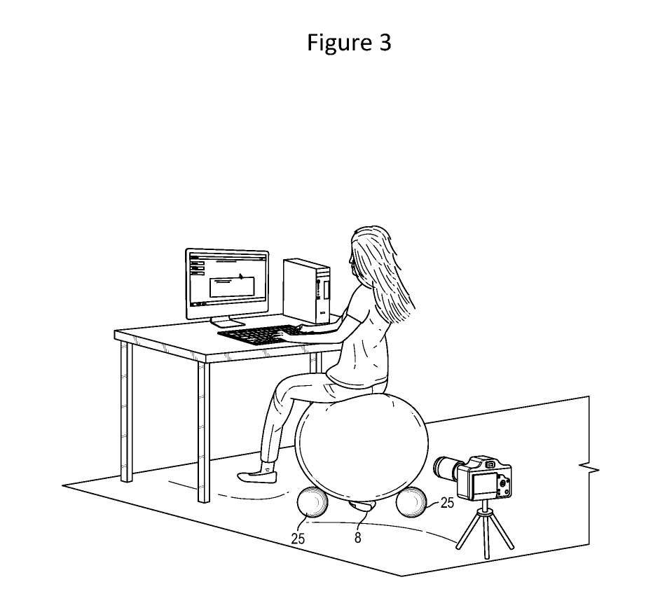

With reference to FIG. 3, the support 5 is shown positioned on a set of rollers 25 for supporting the support 5 and maintaining it in one position even while rolling, while the camera 15 monitors the movement of the support. Other methods can be used to keep the support 5 in approximately the same location during user movement. In another embodiment, the rollers 25 are electronically monitored and provide input, wherein one set represents an X-axis input and a perpendicular set represents a Y-axis input. As the user moves on the support 5, the support rolls or changes angle, pushing the rollers 25 in one direction or another and registering movement with the system movement processor, or sending the raw movement data to the computer 2 for processing to determine cursor input. In the first embodiment, the rollers 25 ensure that the support stays in place, permitting it to rotate with the user on it, wherein it does not move away from it's location on the floor as a result of to the user rotating the ball. In another embodiment, the orientation monitor 8 is mounted below the support 5 position, such that the support 5 rotates above the monitor 8, supported by the rollers 25.

In use, the position-monitor 8 or camera 15 captures sequential frames of image data that correspond to movement of the support 5, and therefore of the user 1. An electronic image processor, which may comprise an FPGA, an ASIC, a processor or otherwise 34, wherein some or all of the processing could be in the device as shown in FIG. 7, or processed within the computer 2 that is receiving the input. The processing quantifies the movement of the support 5, as detected by the optical receiver 10, and transmits corresponding data on the user's movement to the computer or converts the user's movement into a cursor movement on the computer 2. The interface to the computer or electronic device could be through common interface standards such as USB, or through wireless methods such as Bluetooth, Wi-Fi, etc.

FIGS. 1 and 2 illustrate a user engaged with the device in a single representative frame of data. The data is captured by the optical mouse or position-monitoring device and used to determine user and device movement in subsequent frames, as may be known in the art through image processing such as optical flow sensors. The comparison of the adjacent frames permits a movement direction and distance, as well as velocity (based on frame history) to be determined as movements continue between frames (even acceleration with a few frames), or change as frames are compared using an image processor within the system or in an attached computer system.

In an embodiment, the position-monitor 8 or camera 15 utilizes one or more algorithms to determine the position or velocity of the support, user, or other objects in order to transmit data to the graphical user interface of the computer 2. The algorithm may filter out sudden movements and unintended movements that are either preprogrammed or learned by the device, for example when a repeated unintended movement makes the cursor move, and the user repeatedly corrects in the same way. In an embodiment, the algorithms may be carried out in whole or in part on the computer to which the input device is connected. Algorithms may include computing either relative movement or absolute movement by using modern optical flow algorithms to determine motion direction and distance. Other algorithms could include simply looking at the support pattern 21 or outline of support 5 from the sensor edges and calculating the location based on the pattern or outline within the sensors field of view to determine x and y position. With reference to FIG. 2, support 5 movements in X and Y as shown in FIG. 2 can be translated into X and Y coordinates/movements on the computer display 3. When the user rolls the support 5 forward, the pattern 21 moves up and is sensed by the position monitor 8 or image sensing camera 15 and translated into movement in the Y coordinate on the display 3 (wherein the result is interpreted by the computer, moving the cursor up for example). When the user moves to the left (X coordinate) it rotates the support 5 to the left, from the camera's 15 perspective. Detection of the pattern 21 rotating (particularly noticeable if are lines in the pattern, such as a cross-hatching) or the pattern 21 moving to the left (such as a circle) can be used to detect user movement to the left, and the system can transmit corresponding X-coordinate movement to the computer 2. Based on the input, the computer 2 may move the cursor to the left on the display screen. The pattern 21 may include one or more circles, concentric in one embodiment, lines, cross-hatching or grid patterns, or other patterns (speckles, for example) common in the industry to detect movement with a sensor. Also some patterns 21 could be placed across the entire support 5, to permit the support to rotate freely over time while still producing the same effect for the camera 15 or position monitor 8. An example of this pattern 21 may be small squares, which would make it easier for the user so they don't have to line up a target/pattern and could have the ball in any orientation. Other patterns may comprise circles, squares, lines, textures, or other patterns that lend themselves to optical detection and comparison. If the camera 15 captures at a high enough frame rate, then it can monitor the smaller squares motion and translate that into X and Y movement. In order to determine the velocity of the movement, the camera 15 requires a minimum frame rate for continuity of the movement of the pattern 21. If the user bounces or applies more or less pressure the pattern 21 could distort or move in such a way that the position monitor 8 or 15 can detect this, for example a bounce may be interpreted by the computer as a click. The image outline of the support 5 could also be used to detect its movement by the user.

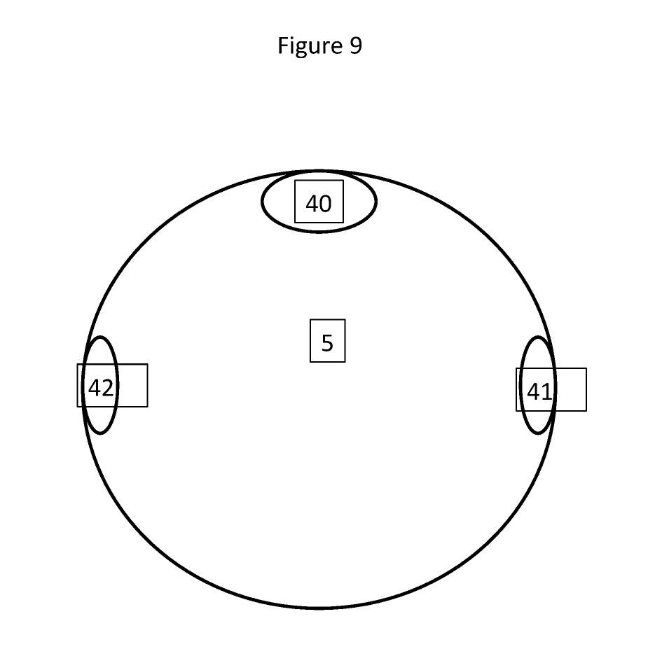

FIG. 9 shows a support 5 with an accelerometer or other movement detection device 40 inside the support along with other sensors 41 and output devices 42 such as haptic feedback or sound. These could be placed inside or outside of the support and located at other locations other than what is represented in the figure. The sensor 40 would provide data to the electronic device based on the users movement of the support similar to FIGS. 1 and 2. The support may also comprise a haptic feedback 41 or microphone 42, or button for a user to press etc.

In a preferred embodiment, the user manually programs command settings and interpretation. For example, a sudden change of the support's profile, such as when pressure is applied to the support, may result in the cursor selecting, zooming in or out, changing the window, or other manipulations known in the art in respect to the graphical user interface. In an embodiment, a microphone is positioned within the support to detect if a user taps on the support 5, which would signal a user input like a button press. Haptic feedback through the support 5 may also be useful to confirm user input, and to this end a vibratory device 42 in FIG. 9 or speaker may be positioned within the support 5 or on the inside surfaces 20 to vibrate or produce sound for feedback to the user.

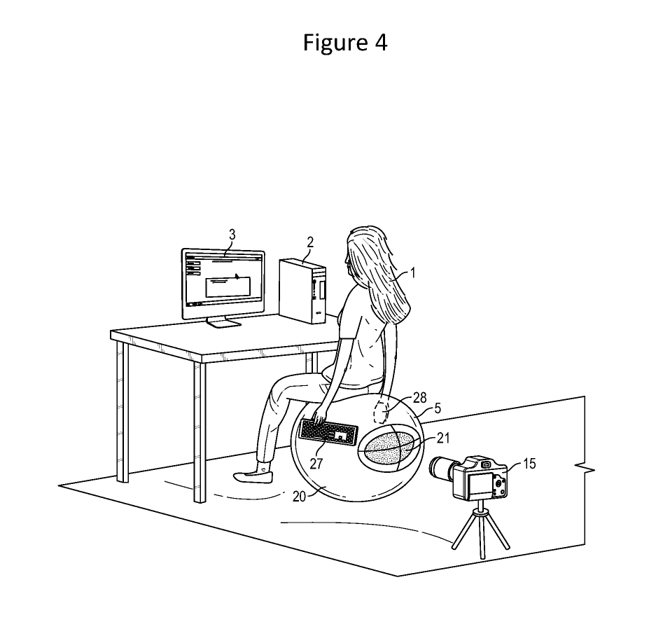

With reference to FIG. 4, components such as keyboard 27 and mouse 28 may be mounted within the support 5 or on the support's surface 20, and the components may also comprise accelerometers or motion detection devices as well as a microphones and vibratory devices. Different applications may require more extensive integration of device and user motion sensing. For example, a computer game may allow for movement of the device in 3-dimensional space, movement of the user, and movement of the auxiliary devices to be augmented in the graphical user interface. Amplitudes of these motions may proportionally, or non-proportionally manipulate the cursor, and a faster movement, for example, may move the cursor more for a given movement of the support than a slow movement of the support.

Algorithms associated with transmitted data to and from the device or position-monitoring system can be performed within the system or by the computer to which it is attached.

In an embodiment, specific locations on the support and user are utilized for specific and independent functions in the graphical user interface. For example; hands and joints of a user, and edges of the device, are used to augment specific functions within the graphical user interface.

In reference to FIG. 3, a mechanical embodiment of the device is illustrated wherein the support 5 is removable and replaceable and rests on rollers. In a preferred embodiment, the support 5, in this embodiment a medicine or exercise ball, is placed atop one or more rollers such that the medicine or exercises ball 5 contacts each roller. Tilting of the exercise ball 5 results in rotation of the rollers. The rotational direction of the rollers 25, in relation to an x-axis and y-axis are transmitted to the computer 2. In an embodiment, a pressure sensor is incorporated into each of the one or more rollers, allowing the user to modulate weight distribution for additional augmented controls.

In an embodiment, one or more pressure sensors (combined with 8) are positioned under the device to monitor movement of the support 5 and determine if a pressure-based “click” is provided by the user 1. Pressure sensors may be used in addition to or in lieu of rollers 25, or other rotation sensing devices. In an embodiment, the pressure sensor detects abrupt changes in total pressure. These changes are transmitted to the computer 2 for augmentation within the graphical user interface. Pressure sensing or contact sensing under the support such as with a pressure sensitive or contact sensing mat may also be used to detect movement of the support and translated into X and Y coordinates.

In an embodiment, the system comprises one or more pressure sensors and/or accelerometers to detect movement by the user. For example, pressure sensors can be integrated into the surface of the medicine ball embodiment, such that as the ball is rotated, changes in the location and vector of forces on the ball are transmitted to the computer.

In an embodiment, an accelerometer 40 is disposed within the device (See FIG. 9). The accelerometer is in communication with the computer and is configured to augment movement on the graphical user interface. In an embodiment, the accelerometer is mounted to the surface of the support, or under the surface of the support, or inside the surface of support.

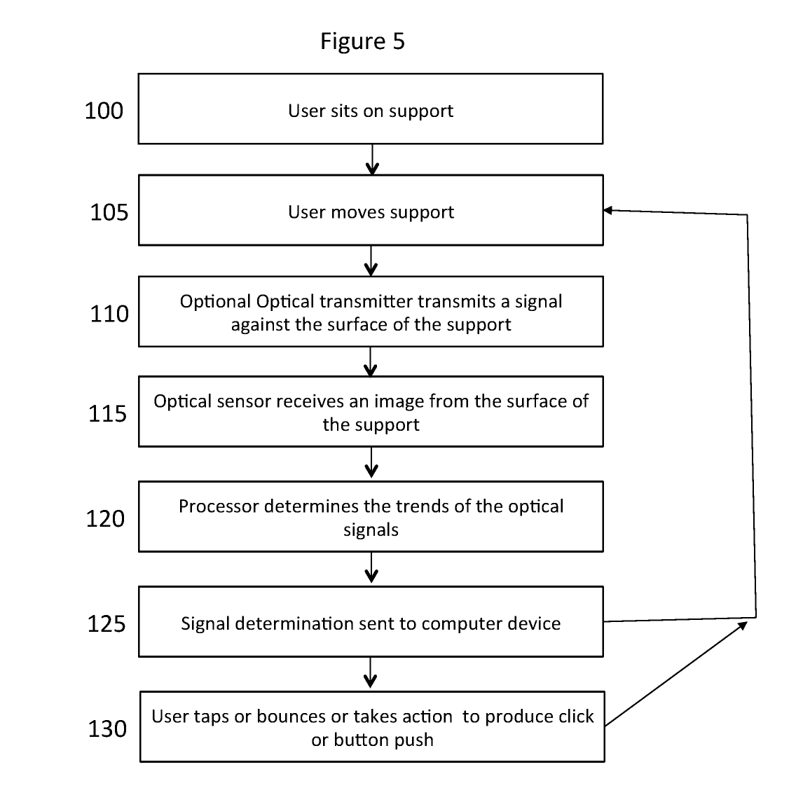

With reference to FIG. 5, a method of using an input device is also described. In step 100, the user sits on a support, which may be a medicine ball or exercise ball. In step 105, the user moves their body to move the support 5, In an embodiment, left and right rotation of the support may be interpreted as left and right (x-axis) cursor movement, and forward and backwards rotation may be interpreted as up and down (y-axis) cursor movement. In step 110, an optical transmitter or light source transmits a signal against the surface of the support, and in step 115, an optical receiver receives the signal reflected from the surface of the support. Steps 110 and 115 could be repeated several times to detect subtle movement of the support, and movement and velocity recorded. In step 120 a processor determines the trends of the optical signals, to produce a signal indication movement of the support, which in step 125 is sent to a computer device to which it is in communication with, and for which it is a cursor or gaming input device. The computer accordingly moves a cursor or a player on the screen is moved in accordance with the movement of the user on the support. In step 130, the user taps or bounces on the support to produce a mouse click or a gaming button.

For example, the support 5 may have a microphone therein, and a ‘tap’ or thump sound from the microphone so the user can rest their hands down near the ball. Detecting things like the user rolling their shoulders (which is healthy too) to signify a mouse click would give the user the benefit of shoulder movement in addition to core strengthening and movement. A button on the side of the ball/object may be touched or tapped, or a glove or other appendage mounted on the user's hand or finger would permit tapping to signify a mouse click, for example. See FIG. 4 showing how a keyboard could be placed, for example, a full keyboard is illustrated (however half of the keyboard on each side of the ball may be more practical and not shown in the figure) so the user can keep their hands by their side without having to lift their hands to use a keyboard in front of them. The keyboard may be attached by removable means, such as hook-and-loop components or more permanent means, such as gluing it (split ½ on each side) such that the user can avoid having their shoulders up and tension on their shoulders/back by having the keyboard down by their side, at a natural resting point for the hands. In an embodiment the keyboard may be built into the surface of the support, as an example, flexible circuitry on the surface of the support, and the buttons for the mouse could be put on the support in this fashion, comprising either mechanical buttons attached to the side or built on the ball itself. Texture could be used so the user can easily feel the key locations and provide tactile feedback so they don't have to look down in order to find the correct keys/buttons. Note these may be RF- and battery-operated so that wires or cables do not get in the way. In an embodiment, the keyboard is self-powered where the movement of the user on the support would generate enough power to operate the keyboard on the support. Alternate locations for the keyboard could include having the keyboard in the users lap and moving with the users movement, or on a keyboard tray or on the desk. The support could contain a weight to help self-orient the support to a default position (for example placing a weight at the bottom of the support).

This invention does require some level of body core movement that is carefully controlled for precise positioning on the electronic device. One effect is that it motivates the user to use core muscles for this motor movement, which should be healthier than traditional mousing that results generally in over-exercising muscles in the hands or arms/shoulders without providing any core workout.

Electronic devices that the input device could interface with may include computers, smartphones, tables, game consoles, and other devices that require user input for moving a mouse or a character on-screen, or anything that could be translated from user movement into meaningful input in an electronic device. Other input methods may be buttons on or near the support 5, a keyboard on or near the support, microphones on the support, pressure sensors on the support. The movement of the support 5 is monitored so as to provide input if the user moves the support, bounces on it, provide vibration or taps it, or sudden movements. The input device may also provide feedback such as haptic feedback on or in the support, lights on or in the support, or sound on or in the support.

The user input device may be adjusted for sensitivity of user movement, and the user can specify that more or less movement be required for a given mouse movement on-screen. This gives the user control over how much exercise he or she is given by moving the support. Multiple input devices may be used to provide input to the computer, each device having independent sensitivity control, allowing the user to disable the input device momentarily and use another input means such as a mouse or pointer. Interface to the computer may be through wired means or wireless means, such as Bluetooth or Wi-Fi.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An electronic input device comprising:
a. an orientation monitor; and
b. a support;
wherein the orientation monitor monitors a movement of the support, wherein the movement of the support is determined by a user, wherein the user sits on the support, and wherein the movement of the support is communicated to an electronic device to provide user input of the electronic device.

2. The device of claim 1, wherein the orientation monitor is in communication with a biasing mechanism that biases the orientation monitor towards the support.

3. The device of claim 1, wherein the support includes one or more buttons for user input.

4. The device of claim 1, wherein the support includes haptic feedback.

5. The device of claim 1, wherein the support contains a vibration sensing device that can detect if the user taps the support and be used as user input.

6. The device of claim 1, wherein the orientation monitor comprises one or more accelerometers to provide movement information over one or more axes.

7. The device of claim 1, wherein the orientation monitor includes one or more pressure sensitive devices and is in contact with the support that can determine location of support relative to the device.

8. The device of claim 1, wherein the orientation monitor includes one or more contact sensitive devices and is in contact with the support that can determine location of the support relative to the device.

9. The device of claim 1, wherein the orientation monitor includes one or more RF devices capable of detecting movement of the support.

10. The device of claim 1, wherein the orientation monitor includes one or more optical devices capable of detecting support movement.

11. The device of claim 1 further comprising:
a. a platform that stays stationary relative to the floor, that allows the support to rotate;
wherein the platform holds the support in a fixed position relative to the floor.

12. An electronic input device comprising:
a. an orientation monitor comprising one or more image sensors having a lens, wherein the lens is configured to focus on the support; and
b. a user sitting on a support,
wherein the orientation monitor monitors a movement of the support, wherein the movement of the support is determined by the user, and wherein the movement of the support manipulates a graphical user interface.

13. The device of claim 12, further comprising a light source, wherein the light source emits light onto the support.

14. The device of claim 12, wherein the support has a pattern thereon, and movement of the support is through sensing the pattern movement.

15. The device of claim 12, wherein the outline of the support is sensed with the image sensor to determine movement of the support.

16. A method of providing input to an electronic device, comprising the steps of:
a. a user sitting on a support;
b. a user moving the support;
c. an optical sensor receiving an image reflected from the surface of the support;
d. the optical sensor monitoring the surface of the support;
e. a processor determining the trends of the optical signals; and
f. the processor sending a signal determination to the electronic device.

17. The method of claim 16 further comprising the step of the optical light source transmitting a signal against the surface of the support.

18. The method of claim 16 further comprising the step of the user tapping the support to produce a mouse click.
